(19) United States
(12) Patent Application Publication
(10) Pub. No.: US 2010/0201538 A1
(43) Pub. Date: Aug. 12, 2010

(54) EVACUATION STATUS MODULE (ESM)

(76) Inventors: Saundra Janese Stevens, West Union, OH (US); Robert Glenn Fuller, West Union, OH (US)

Correspondence Address: PORTER WRIGHT MORRIS & ARTHUR, LLP;INTELLECTUAL PROPERTY GROUP, 41 SOUTH HIGH STREET, 28TH FLOOR, COLUMBUS, OH, 43215, US

(21) Appl. No.: 12/709,875

(22) Filed: Feb. 22, 2010

Related U.S. Application Data
(63) Continuation-in-part of application No. 11/764,198, filed on Jun. 16, 2007, now Pat. No. 7,667,613.
(60) Provisional application No. 60/816,483, filed on Jun. 27, 2006.

(51) Int. Cl. G08B 3/00; G08B 5/00; G08B 7/00; G08B 21/00

(52) U.S. Cl. 340/691.1; 116/100

(57) ABSTRACT

A new device used in institutions such as, but not limited to, hospitals, nursing homes, and other patient-care facilities, and hotels and cruise ships which, when activated, provides a visual indication locally, at or near the room to which it is attached, and remotely at a central control station and/or hand held device, as to whether or not a particular room has been evacuated during an emergency evacuation situation.

### CROSS-REFERENCE TO RELATED APPLICATIONS

This application is a continuation-in-part of U.S. patent application Ser. No. 11/764,198 filed on Jun. 16, 2007 which claims the priority benefit of U.S. provisional patent application number 60/816,483 filed on Jun. 27, 2006, the disclosures of which are expressly incorporated herein in their entireties.

### STATEMENT REGARDING FEDERALLY SPONSORED RESEARCH

Not Applicable

### REFERENCE TO APPENDIX

Not Applicable

### FIELD OF THE INVENTION

The field of the present invention generally relates to systems and methods for evacuating structures having a plurality of inhabited rooms and, more particularly, to systems and methods for keeping track of which rooms have been evacuated.

### BACKGROUND OF THE INVENTION

Many hospitals and nursing homes are required by State, Federal, and International laws to establish and document emergency evacuation procedures. In the case of a fire emergency, these institutions are required, among other things, to document a method for evacuating all patients from their rooms to a safe area. One critical aspect of the evacuation process is effective communication among staff as to which rooms have been evacuated. State, Federal, and in some cases, International regulations leave the method of communication up to each institution's administration. As such, several techniques have been developed. These include, but are not limited to, the use of pillow cases left on the floor outside the evacuated room, orange tags placed on a hook on the outside of the door of the evacuated room, and the use of a chalk mark on the outside of the door of the evacuated room. Each of these communication systems has weaknesses and does not provide the most efficient method of communicating the evacuation status of the affected room. These methods put patients, staff, and rescue personnel at unnecessary risk. In general, the shortcomings of each of these devices and other similar devices not mentioned here are the following: (1) They require retrieval from a storage location—The current methods utilize items that are not located at the point of use. Therefore items must be retrieved at the time of the emergency which takes valuable time away from the evacuation process; (2) Items utilized could be misplaced—Items utilized in the current methods are not affixed to the point of use, possibly resulting in being misplaced and not available at the time of the emergency; (3) Application of the method is clumsy and/or difficult—Getting the pillowcase off of the pillow is clumsy and placing a sign on a hook can be difficult in a tense situation thus again wasting valuable time; (4) These methods and devices may not hold up to either the heat from a fire (in the case of the chalk or the sign) or the traffic of the evacuation process (in the case of a pillow case on the floor). In either case, the indicator is rendered inadequate resulting in no communication to other evacuation personnel; (5) These methods and devices would be difficult to see in conditions of poor visibility (i.e. smoke or dim to no light); and (6) These devices do not provide an efficient means of communicating the evacuation status of each room to which they are employed at a location other than at the location (room) on which they are being used. They cannot communicate to a remote location or remote devices where the evacuation status of rooms can be strategically used to manage a mass evacuation of a facility. As a result, rescue personnel and/or staff must return to and/or enter a dangerous area to evaluate the area for evacuation status of the occupants.

The device proposed in this application provides a consistent, efficient method for indicating the evacuation status of the room to which it is attached. Once triggered, it will indicate that the room to which it is attached has been evacuated in the following ways: (A) Physical, visual indication hanging on, or near, a door to a particular room displaying an evacuation symbol common to those in the building; and (B) Either one or both of the following, wireless or via low voltage hard wired communication signal to a central control station and/or hand held devices.

It will improve the evacuation process of institutions where it is used and will save lives of patients, staff, and rescue personnel by eliminating duplicate searches of rooms previously evacuated. Accordingly, there is a need in the art for an improved system and method for communicating the status of an evacuation.

### SUMMARY OF THE INVENTION

The present invention provides a system and method for indicating evacuation status which overcomes at least some of the above-noted problems of the related art. According to a disclosed embodiment of the present invention, an Evacuation Status Module (ESM) is provided which, when activated, indicates that the room to which it is attached, has been evacuated of all occupants. Use of the ESM saves lives by saving rescue personnel valuable time during an emergency evacuation. It eliminates the need to search a room that has already been evacuated and electronically updates facility control stations and/or hand held devices as to the status of the evacuation process throughout the facility. As a result, rescue personnel can proceed to other rooms or areas of the affected premises that have not been evacuated. Furthermore, staff and/or rescue personnel can utilize the real-time data at either the main facility control station or on handheld devices, (or both), to strategically carry out the evacuation process in the most efficient manner possible. The ESM is mounted on the exterior side of a room near or on the room's exit door. During an evacuation situation, when all occupants have been removed from (or have exited) the room, the ESM is manually activated. It then serves as an indicator to anyone searching or evacuating at a later time that the room is empty.

The disclosed device solves problems with other prior methods by providing: 1. easy access (i.e. the device does not have to be retrieved to be used and it is mounted to the outside of the door or adjacent frame); 2. known whereabouts at all times; 3. simple application (press of a button); 4. durability in extreme conditions (i.e. the device will hold up to extreme conditions such as heat because it is made of heat resistant material such as metal, composite, or high temperature polymer); 5. high visibility (i.e. the device is coated with a highly visible reflective coating such as heat resistant paint, anodized coating, or other mechanically or electrodeposited coating which makes it more able to be seen in poor visibility conditions such as smoke or dim-to-no light); and provides instant, real-time, information to staff and rescue personnel via a facility's central control system or handheld devices, or both, to allow them to strategically carry out the evacuation process in the most efficient manner possible

From the foregoing disclosure and the following more detailed description of various preferred embodiments it will be apparent to those skilled in the art that the present invention provides a significant advance in the technology and art of systems and methods of indicating evacuation status. Particularly significant in this regard is the potential the invention affords for providing a reliable and low cost device. Additional features and advantages of various preferred embodiments will be better understood in view of the detailed description provided below.

### BRIEF DESCRIPTION OF THE DRAWINGS

These and further features of the present invention will be apparent with reference to the following description and drawings, wherein:

FIG. 1 is a perspective view of an Evacuation Status Module (ESM) according to a first embodiment of the invention wherein the ESM in a “closed” or “inactive” state;

FIG. 2 is a perspective view of the ESM of FIG. 1 wherein the ESM is in an “open” or “activated” state;

FIG. 3 is a perspective view of an Evacuation Status Module (ESM) according to a second embodiment of the invention wherein the ESM in a “closed” or “inactive” state;

FIG. 4 is a perspective view of the ESM of FIG. 3 wherein the ESM is in an “open” or “activated” state;

FIG. 5 is a side elevational view of the ESM of FIGS. 3 and 4 wherein the ESM is affixed to a structure and in the closed or inactive state;

FIG. 6 is a side elevational view of the ESM of FIGS. 3 to 5 wherein the ESM is affixed to a structure and in the open or active state; and

FIG. 7 is a perspective view of an interior hallway of a structure wherein a plurality of the ESM of FIGS. 3 and 6 is affixed in close proximity of room doors in the hallway.

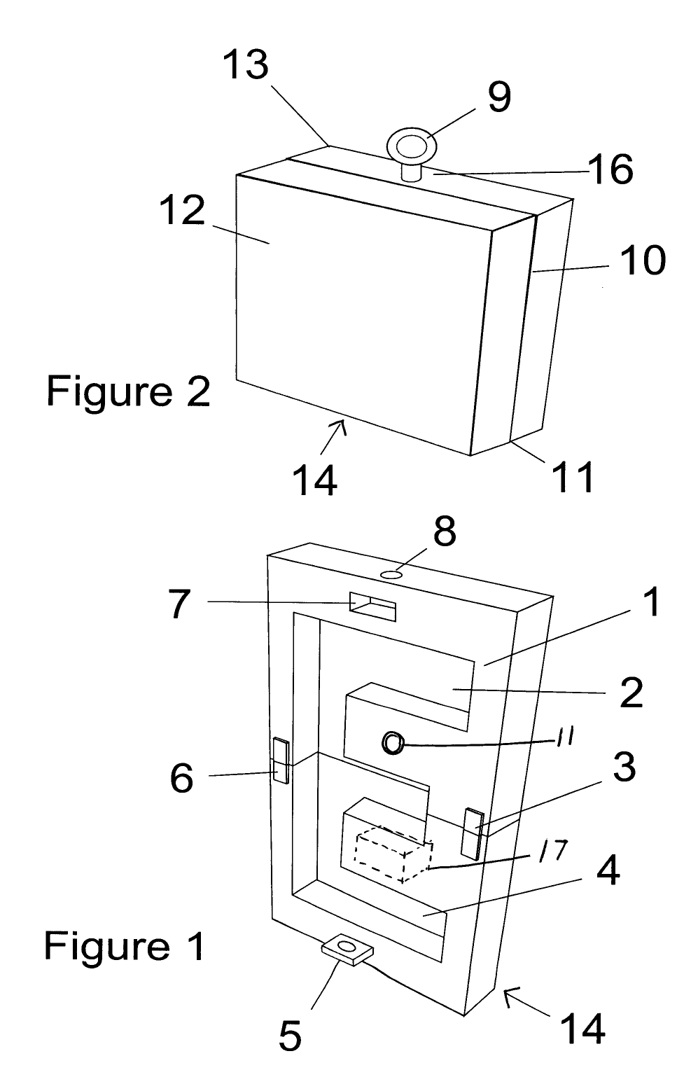

It should be understood that the appended drawings are not necessarily to scale, presenting a somewhat simplified representation of various preferred features illustrative of the basic principles of the invention. The specific design features of the systems and methods for indicating evacuation status as disclosed herein, including, for example, specific dimensions, orientations, locations, and shapes of the various components, will be determined in part by the particular intended application and use environment. Certain features of the illustrated embodiments have been enlarged or distorted relative to others to facilitate visualization and clear understanding. In particular, thin features may be thickened, for example, for clarity or illustration. All references to direction and position, unless otherwise indicated, refer to the orientation of the adjustable control pedal assemblies illustrated in the drawings. In general, up or upward refers to an upward direction within the plane of the paper in FIG. 1 and down or downward refers to a downward direction within the plane of the paper in FIG. 1. Also in general, fore or forward refers to a direction out of the plane of the paper in FIG. 1 and aft or rearward refers to a direction into the plane of the paper in FIG. 1.

### DETAILED DESCRIPTION OF CERTAIN PREFERRED EMBODIMENTS

It will be apparent to those skilled in the art, that is, to those who have knowledge or experience in this area of technology, that many uses and design variations are possible for the improved systems and methods disclosed herein. The following detailed discussion of various alternative and preferred embodiments will illustrate the general principles of the invention with reference to an evacuation status indicator for use in a hospital, nursing home, other patient care facility, hotel, motel, school, dormitory, cruise ship, or the like. Other embodiments suitable for other applications will be apparent to those skilled in the art given the benefit of this disclosure.

FIGS. 1 and 2 illustrate an Evacuation Status Module (ESM) or device 14 according to a first disclosed embodiment of the present invention. The disclosed ESM 14 includes first and second components 12, 13 affixed together and moveable relative to one another between an open state wherein a visual stimulus 1 recognizable by personnel in the field of emergency protocol is visible to indicate that evacuation of a room has occurred and a closed state wherein the visual stimulus 1 is not visible to indicate evacuation of the room has not occurred and a latch mechanism 16 removably holding the first and second components 12, 13 in the closed state until an external input is selectively applied to move the first and second components 12, 13 to the open state.

Referring to FIG. 2, the ESM 14 can be seen in the “inactive” state. The illustrated ESM 14 is shown to be a rectangular cube. However, the ESM 14 can alternatively be shaped in any number of other suitable three-dimensional forms. In the closed state, the ESM 14 is shown to have two halves or components 12, 13 with the first or front (or bottom) half 12 separated from the second or rear (or top) half 13 by a parting line 10. The rear (or top) half 13 is rigidly connected to a wall or door while the front (or bottom) half 12 is pivotably connected to the rear (or top) half 13. The front and rear components 12, 13 are hinged together about a horizontal pivot axis 15 at the bottom of the components 12, 13 so that the front component 12 overlies the rear component 13 in the closed state and a top of the front component 12 pivots downward and outward about the pivot axis 15 to a position located below the rear component 13 in the open state. The device 14 preferably holds up to extreme conditions such as heat because the components 12, 13 are each made of a heat resistant material such as metal, composite, high temperature polymer, or the like.

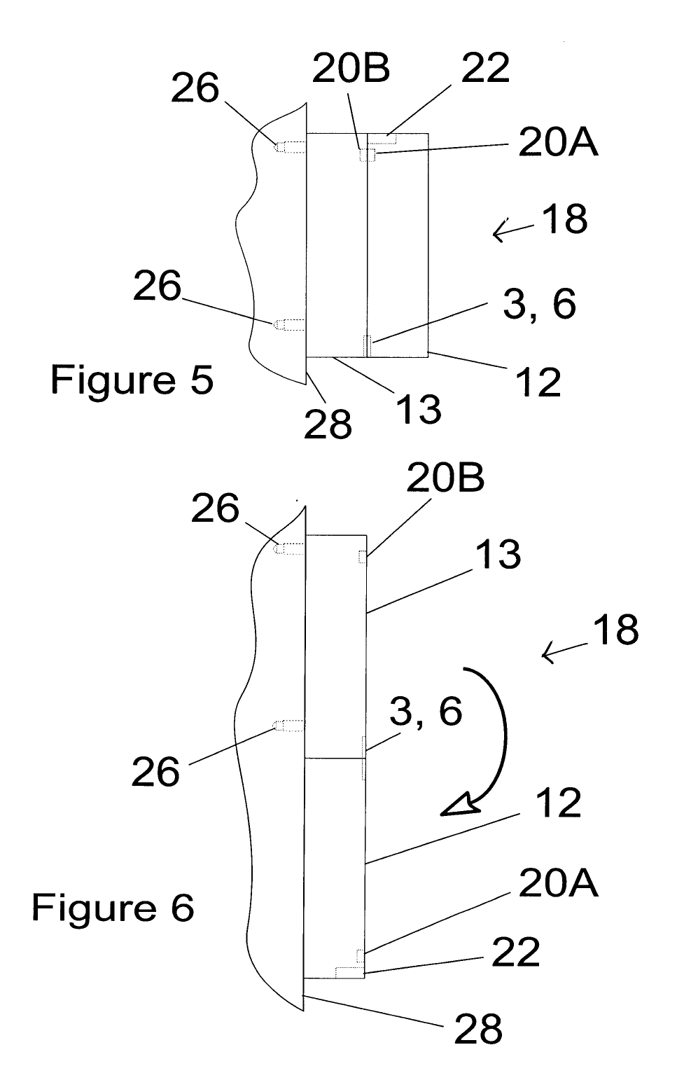

The rear half 13 is mounted on the exterior side of a room near or on the room's exit door (best shown in FIGS. 5 to 7). The rear half 13 can be mounted in any suitable manner such as adhesive, double back tape, mechanical fasteners, hooks, and/or any other suitable fastening means.

Connecting the rear (or top) half 13 of the illustrated device 14 to the front (or bottom) half 12 of the device 14 are a left side mechanical energy storage device/hinge 6 and a right side mechanical energy storage device/hinge 3. For simplicity, these mechanical energy storage devices will be referred to as “spring hinges” 3, 6. The purpose of these two spring hinges 3, 6 is to cause the closed device 14 to spring open when activated and stay open until such time as an authorized person returns the device 14 to the “inactive state”. It is noted that the spring hinges 3, 6 can alternatively be any other suitable type of hinge or hinges and/or the device 14 can alternatively rely on any other suitable type of force such as gravity to move and hold the device in the active state. It is also noted that a spring separate from the hinges 3, 6 can be provided for urging the first and second components 12, 13 to the open state.

The illustrated latch mechanism 16 includes a male end 5 secured to the front half 12, a female end 7 secured to the rear half 13 and sized for receiving the mail end 5, and a locking pin 9 which selectively extends into a hole 8 in the rear half 13 and through an opening in the male end 5 when the ESM 14 is in its closed state to selectively secure the ESM 14 in the closed state. The device 14 is activated by pulling the locking pin 9 from the opening 8 so that the male end 5 is released. When the locking pin 9 is pulled, the device 14 opens along the parting line 10 by rotating the front half 12 about the hinged end 11 of the device 14. It is noted that the latch mechanism 16 can alternatively be any other suitable type of latch mechanism.

The device 14 can be seen in the “active” state in FIG. 1. The “active” state of the device reveals the visual stimulus 1 on the inside of the device 14. The disclosed visual stimulus 1 is in the form of the letter “E”, however the visual stimulus can alternatively be any letter, symbol, sign, or other rendering common to the field of emergency protocol, personnel in the field of emergency protocol, and/or that which is compliant with local, state, federal, or national codes. The visual stimulus 1 serves as a visual and palpable indicator that the associated room has been evacuated.

The illustrated visual stimulus 1 in the form of a cavity 2. The visual stimulus 1 is preferably one of embossed or debossed in the first and second components so that personnel in the field of emergency protocol can alternatively feel the visual stimulus in poor visibility conditions. The illustrated visual stimulus 1 has a coating 4 that is capable of withstanding high temperatures and has a reflective appearance when subjected to a light source. The nature of this coating 4 is such that it enhances visibility in times of poor visibility such as dark or smoky conditions. The color of the coating 4 is selected from those common to the field of emergency protocol, personnel in the field of emergency protocol, and/or in compliance with local, state, federal, or international codes. This could include highly visible and reflective coatings. The coating 4 can be, for example, heat resistant paint, anodized coating, or other mechanically or electrodeposited coating which makes it more able to be seen in poor visibility conditions such as smoke or dim-to-no light.

Also visible in the “active” state is a high intensity flashing light 11. This light 11 begins to flash when the device 14 is activated. This light 11 provides an additional visible indication that the room to which the device is attached has been evacuated and can be used to signal other conditions based on the color it is flashing. The light 11 can be of any suitable type such as, for example, and LED or the like. It is also noted that there can be more than one light 11 and/or the lights 11 can have any other suitable location.

Not visible in either the active state or the inactive state is an electronic module 17. This electronic module 17 is a collection of electronics which, when the device 14 is activated, produces a signal (carried by either a wired and/or wireless connection) indicating that the device 14 has been activated. This signal is carried to the facility's central control station for recording, viewing and/or monitoring. The electronic module 17 is powered either by alternating current (AC) or direct current (DC) supply. This power can be connected to the same circuitry as the facilities other emergency equipment. The signal is generated by the module's emitter. This signal is received at the facility's central control station and/or fire a department station or vehicle or the like, and it can also be received on handheld units carried by facility personnel and/or rescue personnel. It is understood by anyone knowledgeable to the industry that this signal can be carried by, but not limited to, conventional and/or current methods such as infrared, wi-fi, Bluetooth, radio or other such communication means of electronic communication (hard-wired, wireless, fiber-optic, or otherwise).

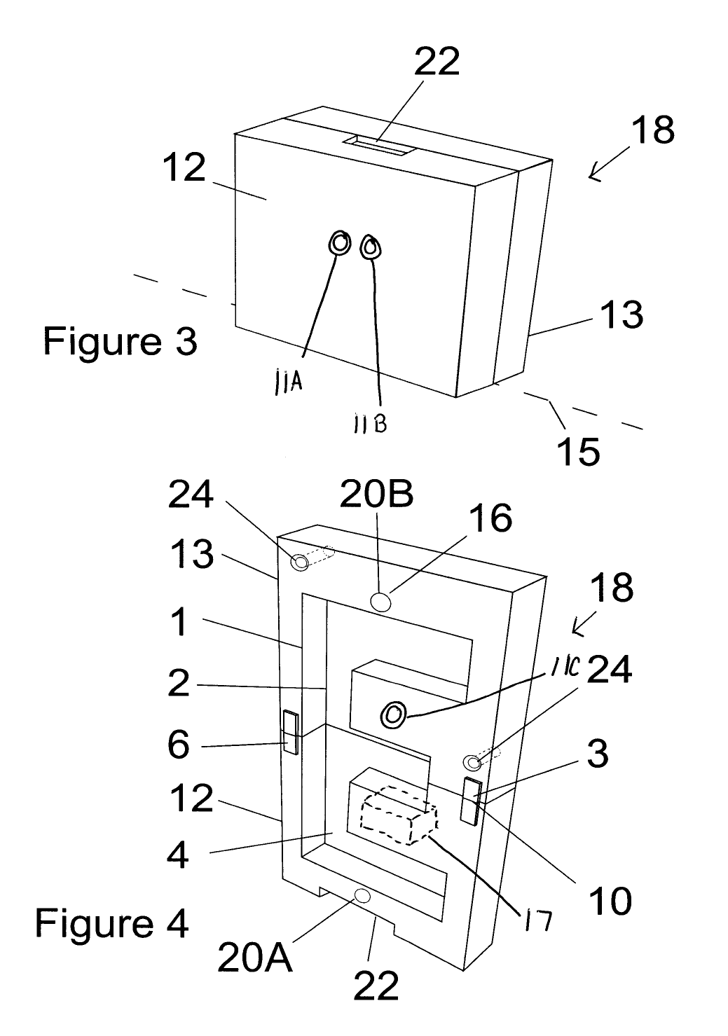

FIGS. 3 to 6 illustrate an Evacuation Status Module (ESM) or device 18 according to a second disclosed embodiment of the present invention. The ESM 18 according to the second embodiment is substantially the same as the ESM 14 according to the first embodiment except as disclosed hereinafter. The illustrated ESM 18 includes a latching mechanism 16 in the form of a magnet latch secured in a position that releasably holds the components 12, 13 together in the inactive state. The illustrated magnet latch is a rare earth magnet latch that includes a pair of rare earth magnets 20A, 20B securely mounted in the front half 12 and the second half 13 respectively with their attracting poles oriented toward each other so that magnetic attraction between the magnets 20A, 20B releasably holds the components 12, 13 together. It is noted that the magnetic latch can alternatively have any other suitable quantity of magnets 20A, 20B. The illustrated front half 12 is provided with a groove or recess 22 at is free end to form a hand grip for pulling the free end to manually release the magnetic connection formed by the magnets 20A, 20B. Additionally, the hinges 3, 6 do not include spring members to illustrate that the scope of the present invention includes different hinges. The device 18 is activated by manually pulling the free end of the front half 12 until the magnet latch is released. When the magnet latch is released, the device 18 opens along the parting line 10 by rotating the front half 12 about the hinged end 11 of the device 18 and is held in the activated state by gravity. It is noted that the latch mechanism 16 can alternatively be any other suitable type of latch mechanism.

The illustrated ESM 18 includes a mount in the form of openings 24 formed in the rear half 13 and mechanical fasteners 26 extending through the openings 24 and into a structure 28 to mount the rear half 13 in a fixed position in proximity to a door, that is, near or on the door. The illustrated mechanical fasteners 26 are in the form of screws but can alternatively be any other suitable type of mechanical fasteners. It is noted that the structure 28 can be any structure having a plurality of inhabited rooms such as, for example, a hospital, nursing home, other patient care facility, hotel, motel, school, dormitory, cruise ship, or the like.

The illustrated ESM 18 includes a pair of outer indicator lights 11A, 11B which are visible when the ESM 18 is in the inactive state and an inner indicator light 11C which is visible when the device is in the activated state. It is noted that the ESM 18 can alternatively have larger or smaller quantities of indicator lights and/or the ESM 18 can have one or more indicator lights 11 that are visible when the ESM 18 is in both the inactive and the active state. The outer indicator lights 11A, 11B are preferable red and white and flash if the ESM 18 is in its inactive state (indicating that its associated room has not been evacuated) and one of the other devices 18 in the facility has been activated and/or the facility's central control station or emergency system has triggered the system indicating that the facility needs to be evacuated. When the evacuation system has not been triggered, the outer indicator lights 11A, 11B can be either off or have steady illumination of a different color such as, for example, green which indicates that the system is powered and operating. The inner indicator light is preferable green and flashes when the ESM 18 is in its active state (indicating that its associated room has been evacuated). It is noted that the indicator lights 11 can alternatively have any other suitable colors to indicate a particular state of the device and/or system.

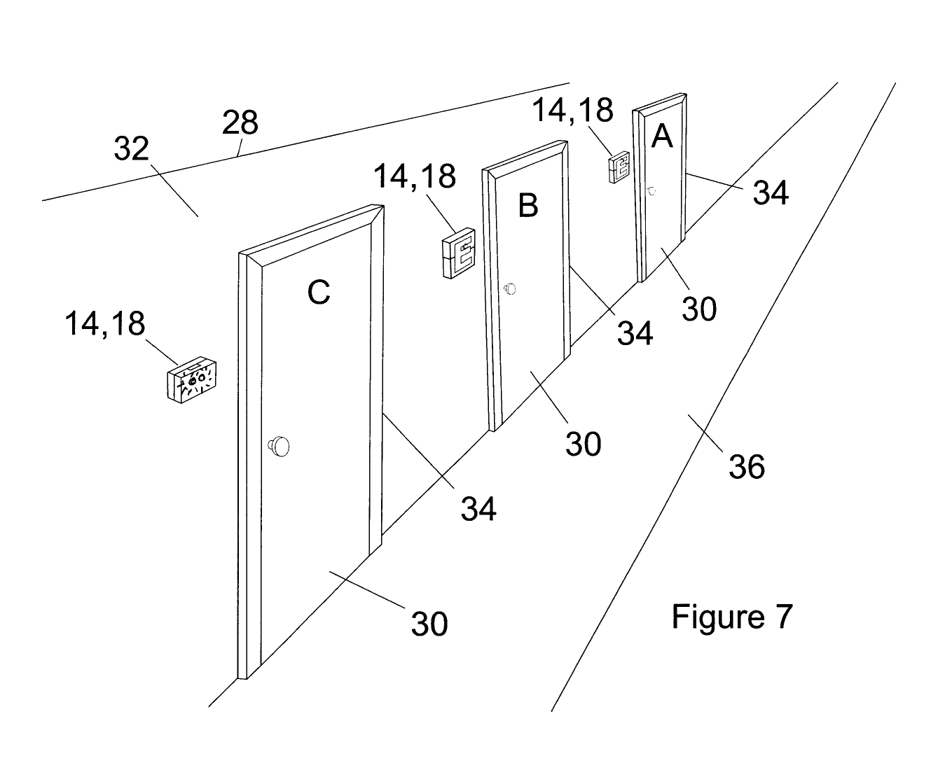

FIG. 7 illustrates the system for indicating evacuation status having a plurality of the ESM 18 mounted to the facility or structure 28. The ESM 18 are mounted on the exterior side of a plurality of rooms near the exit doors 30 of the rooms on the walls 32 or door frames 34 or on the exit doors 30 of the rooms. The illustrated ESM devices 18 are mounted in close proximity of the exit doors 30 in an interior hallway 36 of the structure 28 but alternatively can be located on the exterior portion of the structure 28. Within this specification and claims, the term “close proximity” is intended to mean on the door, on a frame of the door, or on a wall or other object adjacent the door or frame within a few feet of the door or frame.

During an evacuation situation, when all occupants have been removed from (or have exited) a room, the associated ESM 18 is activated. When the ESM 18 is in its activated state, both the visual indicator or symbol 1 and the flashing green indicator light 11C are visible indicate that the room to which the device 18 is attached has been evacuated of all occupants. The activated ESM 18 serves as an indicator to anyone searching or evacuating at a later time that the room is empty. As a result, rescue personnel can proceed to other rooms or areas of the affected premises that have not been evacuated. A device 18 which is still in its inactive state during an emergency situation, such that the visual indicator or symbol 1 is not visible and the flashing red and white indicator lights 11A, 11B are visible, indicates that the associated room to which the device 18 is attached has not been evacuated of all occupants. As a result, rescue personnel know that this room needs to be checked for possible evacuation.

The process of activating multiple devices 18 in a given facility during an emergency evacuation provides the status of the evacuation to rescue personnel and staff. For example, as shown in FIG. 7, the devices 18 associated with rooms A and B have been activated to indicate that the rooms have been evacuated while the ESM 18 associated with room C has not been activated which indicates that the room has not been evacuated. Thus, upon seeing or feeling the inactivated device 14, 18 (or based on the electronic signals), rescue personnel would know to focus on room C to look for additional residents to be evacuated. After, the emergency situation is over, the devices 18 are deactivated by closing each device 18 to its closed state. The devices 18 can be reused without limit assuming they are not burned or destroyed during an evacuation event.

From the foregoing disclosure and detailed description of certain preferred embodiments, it is apparent that the disclosed system and devices provide a consistent, efficient method for indicating the evacuation status of the room to which it is attached. Once triggered, the device 18 provides physical (by touch of the symbol 1), visual (the symbol 1 and the indicator light 11C), and electronic (electronic signals) indicators that the room to which it is attached has been evacuated. It is apparent that the disclosed system will improve the evacuation process of institutions where it is used and will save lives of patients, staff, and rescue personnel by eliminating duplicate searches of rooms previously evacuated.

From the foregoing disclosure and detailed description of certain preferred embodiments, it is also apparent that various modifications, additions and other alternative embodiments are possible without departing from the true scope and spirit of the present invention. The embodiments discussed were chosen and described to provide the best illustration of the principles of the present invention and its practical application to thereby enable one of ordinary skill in the art to utilize the invention in various embodiments and with various modifications as are suited to the particular use contemplated. All such modifications and variations are within the scope of the present invention as determined by the appended claims when interpreted in accordance with the benefit to which they are fairly, legally, and equitably entitled.

What is claimed is:

1. An evacuation indicating device comprising:
first and second components affixed together and moveable relative to one another between a closed state and an open state;
wherein the first component is mounted at an exterior side of an interior room near an exit door of the interior room;
a latch mechanism removably holding the first and second components in the closed state until an external input is selectively applied to move the first and second components to the open state; and
an electronic module automatically emitting a signal to a remote control station when the first and second components are moved to the open state to indicate to emergency personnel at the control station the evacuation status of the interior room.

2. The evacuation indicating device according to claim 1, wherein the first and second components are hinged together.

3. The evacuation indicating device according to claim 1, wherein the first and second components are hinged together about a horizontal pivot axis at the bottom of the first component so that the second component overlies the first component in the closed state and a top of the second component pivots downward and outward about the pivot axis to a position located below the first component in the open state.

4. The evacuation indicating device according to claim 1, wherein the first and second components comprise a heat resistant material.

5. The evacuation indicating device according to claim 1, further comprising a visual stimulus recognizable by personnel in the field of emergency protocol to indicate that evacuation has occurred and wherein the visual stimulus is visible when the first and second components are in the open state but not visible when the first and second components are in the closed state.

6. The evacuation indicating device according to claim 5, wherein the visual stimulus is one of embossed and debossed in the first and second components so that personnel in the field of emergency protocol can alternatively feel the visual stimulus in poor visibility conditions.

7. The evacuation indicating device according to claim 1, further comprising a light indicating the status of the device.

8. The evacuation indicating device according to claim 1, wherein the signal is carried by one of a wired and wireless connection.

9. The evacuation indicating device according to claim 1, wherein the signal is relayed to handheld receivers.

10. The evacuation indicating device according to claim 1, wherein the signal is unique to the device to indicate the interior room to which the device is assigned.

11. An evacuation indicating system comprising:
a plurality of evacuation indicating devices mounted at exterior sides of interior rooms near exit doors of the interior rooms;
each evacuation indicating device including:
first and second components affixed together and moveable relative to one another between an open state and a closed state;
a latch removably holding the first and second components in the closed state until an external input is selectively applied to move the first and second components to the open state; and
at least one light indicating the status of the evacuation indicating device; and
wherein the light is visible when the first and second components are in the closed state and is illuminated in a manner to indicate that the interior room associated with the evacuation indicating device has not been evacuated when the first and second components are in the closed state in an emergency situation.

12. The evacuation indicating system according to claim 11, wherein the light is automatically illuminated on each of the plurality of evacuation devices in the closed state when one of the plurality of evacuation indicating devices is in the open state.

13. The evacuation indicating system according to claim 11, wherein the light flashes in an emergency situation when the first and second components are in the closed state to indicate that the interior room associated with the evacuation indicating device has not been evacuated.

14. The evacuation indicating system according to claim 11, wherein there are two of the lights and one flashes red and the other flashes white.

15. The evacuation indicating system according to claim 11, further comprising an electronic module automatically emitting a signal to a remote control station when the first and second components are moved to the open state to indicate to emergency personnel at a control station the evacuation status of the interior room associated with the evacuation indicating device.

16. An evacuation indicating system comprising:
a plurality of evacuation indicating devices mounted at exterior sides of interior rooms near exit doors of the interior rooms;
each evacuation indicating device including:
first and second components affixed together and moveable relative to one another between an open state and a closed state; and
a latch removably holding the first and second components in the closed state until an external input is selectively applied to move the first and second components to the open state;
a plurality of lights indicating the status of the evacuation indicating device;
wherein a first one of the plurality lights is visible when the first and second components are in the closed state and is illuminated in a manner to indicate that the interior room associated with the evacuation indicating device has not been evacuated in when the first and second components are in the closed state in an emergency situation; and
wherein a second one of the plurality of lights is visible when the first and second components are in the open state and is illuminated in a manner to indicate that the interior room associated with the evacuation indicating device has been evacuated when the first and second components are in the open state in an emergency situation.

17. The evacuation indicating system according to claim 16, wherein the first light is automatically illuminated on each of the plurality of evacuation devices in the closed state when one of the plurality of evacuation indicating devices is in the open state.

18. The evacuation indicating system according to claim 17, wherein the first light flashes in an emergency situation when the first and second components are in the closed state to indicate that the interior room associated with the evacuation indicating device has not been evacuated.

19. The evacuation indicating system according to claim 18, wherein a third one of the plurality of lights is automatically illuminated to flash on each of the plurality of evacuation devices in the closed state when one of the plurality of evacuation indicating devices is in the open state, and wherein the first light is red and the third light is white.

20. The evacuation indicating system according to claim 16, wherein the first light is red and the second light is green.
